(19) United States
(12) Patent Application Publication
(10) Pub. No.: US 2024/0046171 A1
(43) Pub. Date: Feb. 8, 2024

(54) SYSTEM AND METHOD FOR AUTHORIZING TIME-OFF FOR A SKILL TO INCREASE AGENTS DIGITAL AVAILABILITY IN A CONTACT CENTER

(71) Applicant: NICE LTD., Ra'anana (IL)

(72) Inventors: Swati KADU, Pune (IN); Salil DHAWAN, Pune (IN); Pramod GIRI, Pune (IN)

(21) Appl. No.: 17/877,944

(22) Filed: Jul. 31, 2022

(51) Int. Cl. G06Q 10/06; G06Q 30/00

(52) U.S. Cl. CPC G06Q 10/063116; G06Q 30/016; G06Q 10/06398

(57) ABSTRACT

A computerized-method for authorizing time-off for a skill to increase agents digital availability is provided herein. The computerized-method includes receiving an agent skill-based time-off request having one or more skills and a duration from a User Interface (UI) in a computerized-device of an agent, and for each skill of the one or more skills in the agent skill-based time-off request: (a) operating an agent-skill-based time-off module to calculate au agent time-off eligibility-quotient. When the agent time-off eligibility-quotient is below a preconfigured quotient-threshold the agent skill-based time-off request is rejected, and when the agent time-off eligibility-quotient is above the preconfigured quotient-threshold, operating an approver module to yield an authorization decision; and (b) sending the authorization decision, details of the skill and duration to a time-off recommendation module to forward the authorization decision, details of the skill and duration to one or more contact-center modules.

### TECHNICAL FIELD

The present disclosure relates to the field of data analysis and more specifically to authorizing an agent time-off request for a skill in a contact center.

### BACKGROUND

In digital contact centers and multi-channel support, agents have to cater to multiple channels and subsequently multiple customers in near real time. In a work from home setup sometimes the agent would prefer not to take voice calls or not to work on synchronous interactive channels e.g., instant message, as there might be some conditions or requirements at home or in any other work environment, which require their attention. The conditions or requirements may include intermittent interruptions, such as, watching over kids, expecting someone at the door, or having chaotic guests at home or alternatively silence may be needed at home.

Moreover, some skills may be overwhelming or require more mental effort, and agents may get burnt out from providing service to customers, such as credit card theft or providing service not in their native language but may be fine with other skills by which they may provide customer service.

In current solutions, in such situations where only some skills which are associated to the agent are available from the agent aspect, even though the agent may be productive in several asynchronous digital skills, such as, email responses, or assisting in a change of address, the agents has to mark themselves as unavailable in the system. e.g., by selecting unavailable codes and remain offline, or alternatively the agent which is marked as available is routed a call when the agent is in a chaotic situation or when the agent is mentally fatigue that may lead to degraded customer experience and reduced agent satisfaction. This lack of flexibility of skills availability may impact the agent productivity, as well as the contact center productivity.

With the increased digital adoption in contact centers, it is imperative to provide flexibility to the agents to opt for specific skills from time to time, to maintain efficiency and increased productivity and to take periodic breaks from certain overwhelming skills. Hence, there is a need for a technical solution that may provide a flexible ‘time off model’ where agents may be able to take breaks from certain skills that require more focus and attention and in parallel ensure work continuity in the contact center.

This needed technical solution of a flexible ‘time off module’ may increase agent affinity towards handling a greater number of digital skills and also motivate agent to be performant across variety of skills. Today, agents unavailability does not take into consideration the contact center skill requirements which is leading to too many agents being unavailable at same time, which as a result, impacting customer wait time.

### SUMMARY

There is thus provided, in accordance with some embodiments of the present disclosure, a computerized-method for authorizing time-off for a skill to increase agents digital availability in a contact center.

Furthermore, in accordance with some embodiments of the present disclosure, the computerized-method may include receiving an agent skill-based time-off request having one or more skills and a duration from a User Interface (UI) in a computerized-device of an agent. The agent has two or more associated skills. For each skill of the one or more skills in the agent skill-based time-off request the computerized-method may further include operating an agent-skill-based time-off module to calculate au agent tune-off eligibility-quotient.

Furthermore, in accordance with some embodiments of the present disclosure, when the agent time-off eligibility-quotient is below a preconfigured quotient-threshold, the agent skill-based time-off request may be rejected, and when the agent time-off eligibility-quotient is above the preconfigured quotient-threshold, the computerized-method may further include operating an approver module to yield an authorization decision.

Furthermore, in accordance with some embodiments of the present disclosure, the computerized-method may further include, sending the authorization decision, details of the skill and duration to a time-off recommendation module to forward the authorization decision, details of the skill and duration to one or more contact-center modules.

Furthermore, in accordance with some embodiments of the present disclosure, the approver module may include: (i) calculating a scheduled-agent-availability for one or more schedules in the duration; (ii) marking the authorization decision as ‘approved’ when the scheduled-agent-availability is marked as ‘on’; and (iii) marking the authorization decision as ‘rejected’ when the scheduled-agent-availability is marked as ‘off’.

Furthermore, in accordance with some embodiments of the present disclosure, when the authorization decision is marked as ‘approved’, the approver module may mark the skill of the agent as ‘unavailable’ in an agents database with details of the duration; and when the authorization decision is marked as ‘rejected’, the approver module may send a deny notification with details of the skill and duration to the computerized-device of the agent.

Furthermore, in accordance with some embodiments of the present disclosure, the duration details may include start date and time and end date and time.

Furthermore, in accordance with some embodiments of the present disclosure, after receiving the agent skill-based time-off request, the computerized-method may further include checking in the database of agents if the agent has one or more skills marked as ‘unavailable’, and when the agent has one or more skills marked as ‘unavailable’, the received agent skill-based tune-off request may be rejected.

Furthermore, in accordance with some embodiments of the present disclosure, after receiving the agent skill-based time-off request, the computerized-method may further include checking in the database of agents if the agent has the skill marked as ‘unavailable’, and when the agent has the skill marked as ‘unavailable’, the received agent skill-based time-off request may be rejected.

Furthermore, in accordance with some embodiments of the present disclosure, the scheduled-agent-availability may be marked as ‘on’, when a scheduled-agent-count is greater than a sum of an agent-requirement-count and an agent requirement threshold, and the scheduled-agent-availability may be marked as ‘off’, when a scheduled-agent-count is lower than the sum of an agent-requirement-count and an agent requirement threshold.

Furthermore, in accordance with some embodiments of the present disclosure, the approver module may further include retrieving the agent-requirement-count for each schedule of one or more schedules in the duration and the agent requirement threshold for each schedule from an agents database.

Furthermore, in accordance with some embodiments of the present disclosure, when the decision is time-off approval for the skill, the computerized-method may further include sending an approval-notification by an approval notification module to be presented via a LEI on a display unit associate to the computerized-device of the agent.

Furthermore, in accordance with some embodiments of the present disclosure, the agent time-off eligibility-quotient may be calculated based on following formula I:
(I) agent time-off eligibility-quotient=Σ(agent quotient+agent skill quotient)/(K+L) whereby:
   the agent quotient may be calculated by following formula II:

$$agent quotient = {\sum }_{k = 1}^{k} {agent\_parameter}_{k} * preconfigured\_parameter {\_weight}_{k} \qquad ( II )$$

whereby:
k is a number of preconfigured one or more agent_parameters, and
preconfigured_parameter_weight is a corresponding weight that is determined for each preconfigured agent_parameter of the preconfigured one or more agent_parameters, and
the agent skill quotient may be calculated based on following formula III:

$$agent skill quotient = {\sum }_{L = 1}^{L} {agent\_performance}_{L} * {preconfigured\_weight}_{L} \qquad ( III )$$

whereby:
L is a number of preconfigured one or more agent_performances, and preconfigured_weight is a corresponding weight that is determined for each preconfigured agent_performance of the preconfigured one or more agent_perfonuances.

Furthermore, in accordance with some embodiments of the present disclosure, the one or more agent_parameters may be selected from at least one of: (i) agent duration in company; (ii) average sentiment in interactions of the agent during a preconfigured period; (iii) rewards and recognitions accredited to the agent during the preconfigured period; (iv) agent absenteeism rate during the preconfigured period; (v) agent occupancy rate; and (vi) average manager-feedback issued during the preconfigured period.

Furthermore, in accordance with some embodiments of the present disclosure, the one or more agent performances during a preconfigured period may be selected from at least one of: (i) average performance in skills that the agent opted to work when one or more skills were marked as unavailable during the preconfigured period; (ii) average customer feedback during the preconfigured period; (iii) escalation count during the preconfigured period; (iv) schedule adherence of agent in shifts during the preconfigured period; (v) last availed time-off request duration from the agent skill-based time-off; and (vii) number of agent digital interactions skills that the agent performed for the preconfigured period.

Furthermore, in accordance with some embodiments of the present disclosure, the agent skill-based time-off request may be forwarded to a supervisor for approval when the eligibility-quotient is below the preconfigured quotient-threshold.

Furthermore, in accordance with some embodiments of the present disclosure, the one or more contact-center modules may include at least one of: (i) supervisor dashboard; (ii) reporting generator; (iii) routing engine; and (iv) scheduling engine.

Furthermore, in accordance with some embodiments of the present disclosure, the supervisor dashboard may present each pending agent skill-based time-off request and each approved or rejected agent skill-based time-off request.

Furthermore, in accordance with some embodiments of the present disclosure, the routing engine may be configured to check the agents database before muting an inbound-interaction to the agent, and when the inbound-interaction requires au agent with a specified skill, the routing engine is not routing the inbound-interaction to an agent that has the specified skill marked as ‘unavailable’.

Furthermore, in accordance with some embodiments of the present disclosure, the operating of the agent-skill-based tune-off module, may be after one or more preconfigured system validations are satisfied and the agent skill-based time-off request is rejected when one or more preconfigured system validations are not satisfied.

Furthermore, in accordance with some embodiments of the present disclosure, the operating of the agent-skill-based time-off module, may be before one or more preconfigured system validations are satisfied and wherein the agent skill-based time-off request is rejected when one or more preconfigured system validations are not satisfied.

Furthermore, in accordance with some embodiments of the present disclosure, the one or more preconfigured system validations may be selected from at least one of: (i) the duration of the agent skill-based time-off request is not in a period that has been configured as a period when a high number of interactions is expected; (ii) a preconfigured first-quota for all scheduled agents for agent skill-based time-off requests has not been reached in a first-preconfigured period; (iii) a preconfigured second-quota for the agent for agent skill-based time-off requests per a second-preconfigured period has not been reached; and (iv) excess number of agents for the skill in the duration of the agent skill-based time-off request.

There is further provided, in accordance with some embodiments of the present disclosure, a computerized-system for authorizing time-off for a skill to increase agents digital availability. The computerized-system may include a memory to store one or more databases thereon, and one or more processors. The one or more processors may be configured to receive an agent skill-based time-off request having one or more skills and a duration from a User Interface (UI) in a computerized-device of an agent. The agent has two or more associated skills; For each skill of the one or more skills in the agent skill-based time-off request the one or more processors may be configured to operate an agent-skill-based time-off module to calculate an agent time-off eligibility-quotient.

Furthermore, in accordance with some embodiments of the present disclosure, when the agent tune-off eligibility-quotient is below a preconfigured quotient-threshold the agent skill-based time-off request may be rejected, and when the agent time-off eligibility-quotient is above the preconfigured quotient-threshold, operating an approver module to yield an authorization decision.

Furthermore, in accordance with some embodiments of the present disclosure, the one or more processors may be configured to send the authorization decision details of the skill and duration to a time-off recommendation module to forward the authorization decision, details of the skill and duration to one or more contact-center modules.

### BRIEF DESCRIPTION OF THE DRAWINGS

FIGS. 1A-1B schematically illustrate a high-level diagram of a system for authorizing time-off for a skill to increase agents digital availability, in accordance with some embodiments of the present disclosure;

FIG. 2 is a high-level workflow of a computerized-method for authorizing time-off for a skill to increase agents digital availability, in accordance with some embodiments of the present disclosure;

FIG. 3 is a flowchart of a computerized-method for authorizing time-off for a skill to increase agents digital availability, in accordance with some embodiments of the present disclosure;

FIG. 4 shows an example of usage of a computerized-method for authorizing time-off for a skill to increase agents digital availability, in accordance with some embodiments of the present disclosure;

FIGS. 5A-5I shown an example of agent time-off eligibility-quotient calculation based on agent quotient and agent skills quotient, in accordance with some embodiments of the present disclosure;

FIG. 6 is an example of a User Interface (UI) in a computerized-device of an agent for selecting an agent skill-based time-off request having one or more skills, in accordance with some embodiments of the present disclosure;

FIGS. 7A-7B show an example of a UI in a supervisor dashboard presenting each pending agent skill-based time-off request and each approved or rejected agent skill-based time-off request, in accordance with some embodiments of the present disclosure;

FIGS. 8A-8B show an example of a notification on skill-based time-off request received by the agent, in accordance with some embodiments of the present disclosure; and

FIG. 9 shows an example of a notification on skill-based time-off request forwarded to a supervisor and received by an agent, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example. “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “digital channel” refers to a communication platform to provide service to customers in a contact center which may be implemented as agent service. For example, chat, Short Message Service (SMS), email and the like.

Customer satisfaction is a measurement that determines how well a company's products or services meet customer expectations. It's one of the most important indicators of purchase intentions and customer loyalty. When a contact center can address customer issues and concerns quickly, it creates better experiences and happier customers. This substantially increase contact center performance by improving agent productivity and utilization as agents may serve customers queries effectively.

Reducing the average wait time may be directly proportional to customer satisfaction. The lesser time it takes for agents to resolve customer needs, the better. Today agent unavailability does not take into consideration the contact center skill requirement which is leading to too many agents being unavailable at same time, resulting in increased customer wait time. Current solutions do not enable agents to be available only for certain skills or communication channel, such as offline digital channel.

Furthermore, current systems in contact centers don't have flexible ‘Time Off model’ that is required where agents can take breaks from providing customer service only in certain skills that need more focus and attention and in parallel ensures work continuity in other skills. Such a technical solution may benefit agents, contact centers as a whole and customers. Also, the needed technical solution may be of paramount importance to increase agent affinity towards handling a greater number of digital skills and also may motivate agents to be performant across variety of skills. Once a multi-channel platform is in place, solving customer queries can be far lower cost. For instance, a webchat session is on average 40% lower cost than a phone call.

Accordingly, there is a need for a technical solution for authorizing skill-based time-off for a skill of an agent to increase digital adoption among agents, thus agents may take breaks from only certain skills that require more focus and attention or from skills which are more overwhelming and in parallel be available and ensure work continuity via other skills.

The needed technical solution may provide agents an option to select unavailability only for certain skills for a certain period to elevate productivity during work from home or any other work setup instead of the agents being completely unavailable.

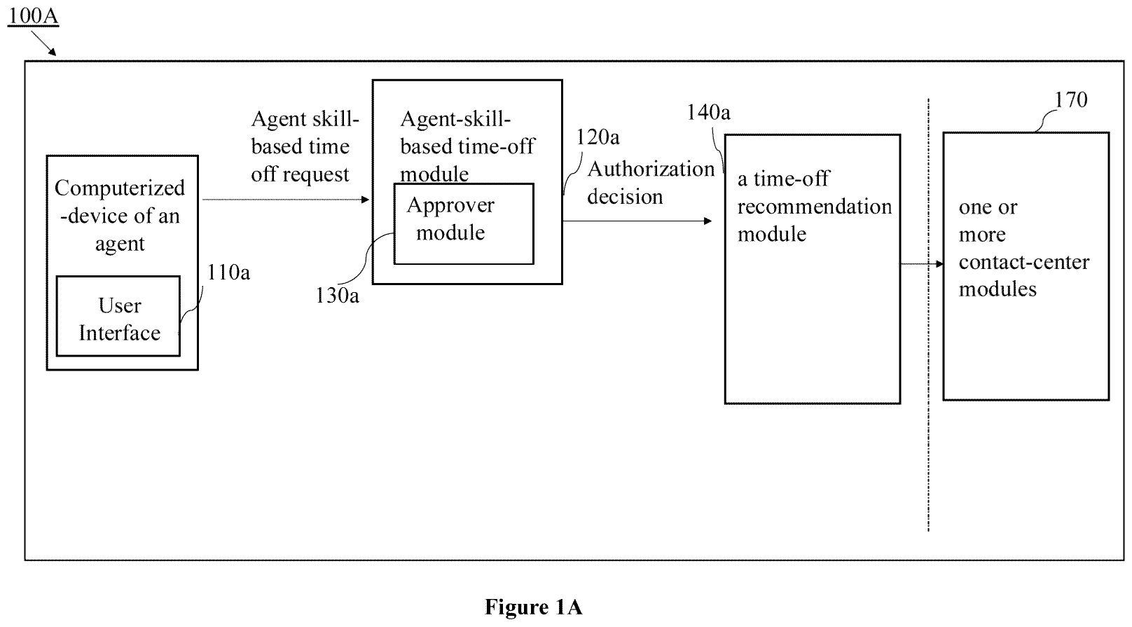

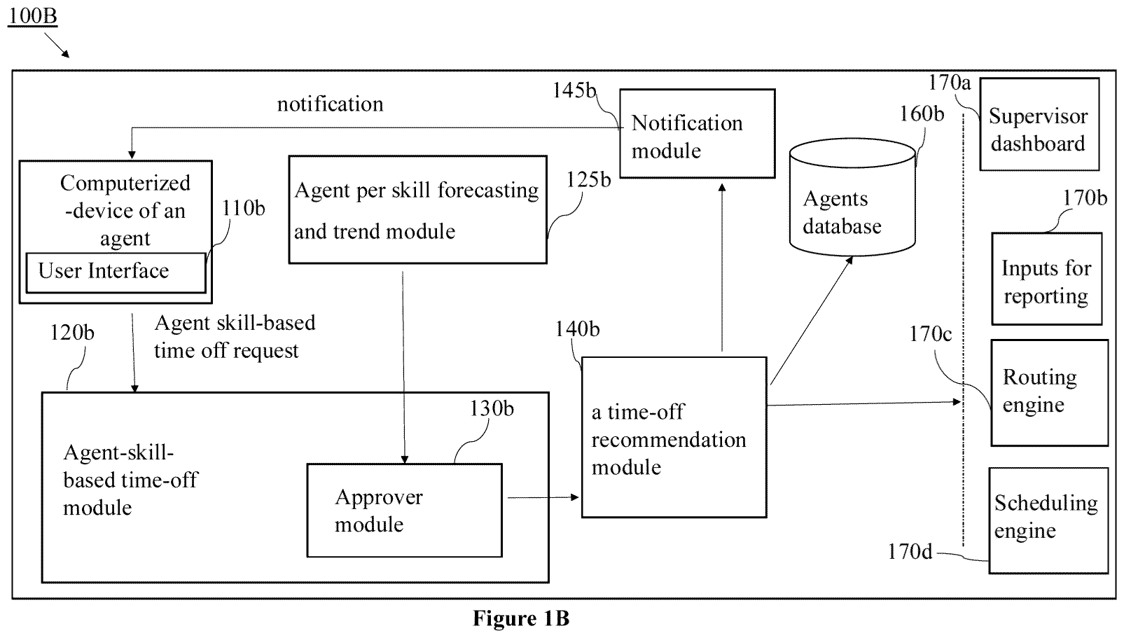

FIG. 1A schematically illustrates a high-level diagram of a system 100A for authorizing time-off for a skill to increase agents digital availability, in accordance with some embodiments of the present disclosure.

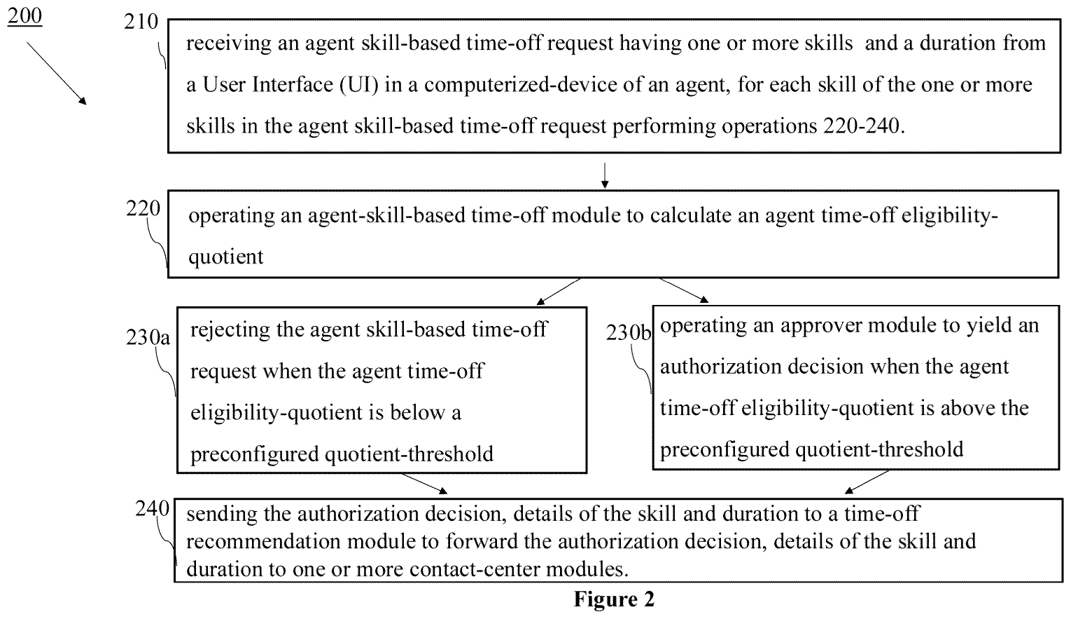

According to some embodiments of the present disclosure, a computerized-system, such as system 100A, may implement a method, such as a computerized-method 200 in FIG. 2, for authorizing time-off for a skill to increase agents digital availability instead of current solutions, which authorize time-off for an agent for all the skills which are associated with the agent.

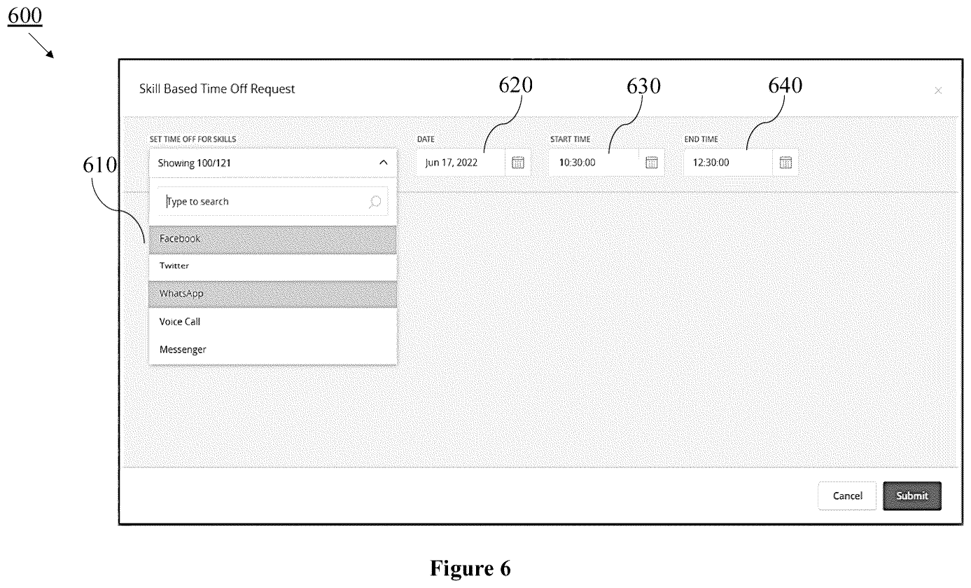

According to some embodiments of the present disclosure, a module, such as agent-skill-based time-off module 120a may receive an agent skill-based time-off request having one or more skills and a duration for the time-off request from a User Interface (UI) in a computerized-device of an agent 110a. For example. UI 600 in FIG. 6.

According to some embodiments of the present disclosure, the agent has two or more associated skills. For example, Spanish, English, credit card theft and changing customer details.

According to some embodiments of the present disclosure, the agent-skill-based time-off module 120a may operate for each skill of the one or more skills in the agent skill-based time-off request to calculate an agent time-off eligibility-quotient.

According to some embodiments of the present disclosure, when the calculated agent time-off eligibility-quotient is below a preconfigured quotient-threshold, the agent skill-based time-off request may be rejected, and when the agent time-off eligibility-quotient is above the preconfigured quotient-threshold, the agent-skill-based time-off module 120a may operate a module, such as approver module 130a to yield an authorization decision. The authorization decision may be rejected when the agent skill-based time-off request is not authorized for the specified duration and approved when the agent skill-based time-off request is approved for the specified duration.

According to some embodiments of the present disclosure, the authorization decision, details of the skill and duration of the time-off for the skill may be sent to a module, such as time-off recommendation module 140a to forward the authorization decision, details of the skill and duration to one or more contact-center modules 170. For example, supervisor dashboard, routine engine and scheduling engine.

FIG. 1B schematically illustrates a high-level diagram of a system 100B for authorizing time-off for a skill to increase agents digital availability, in accordance with some embodiments of the present disclosure.

According to some embodiments of the present disclosure, system 100B may include all the components of system 100A in FIG. 1A.

According to some embodiments of the present disclosure, a module, such as agent-skill-based time-off module 120b may receive an agent skill-based time-off request having one or more skills and a duration for the request may be received from a User Interface (UI) in a computerized-device of an agent 110b, as shown in UI 600 in FIG. 6

According to some embodiments of the present disclosure, the agent that is sending the agent skill-based time-off request has two or more associated skills which relate to customer service.

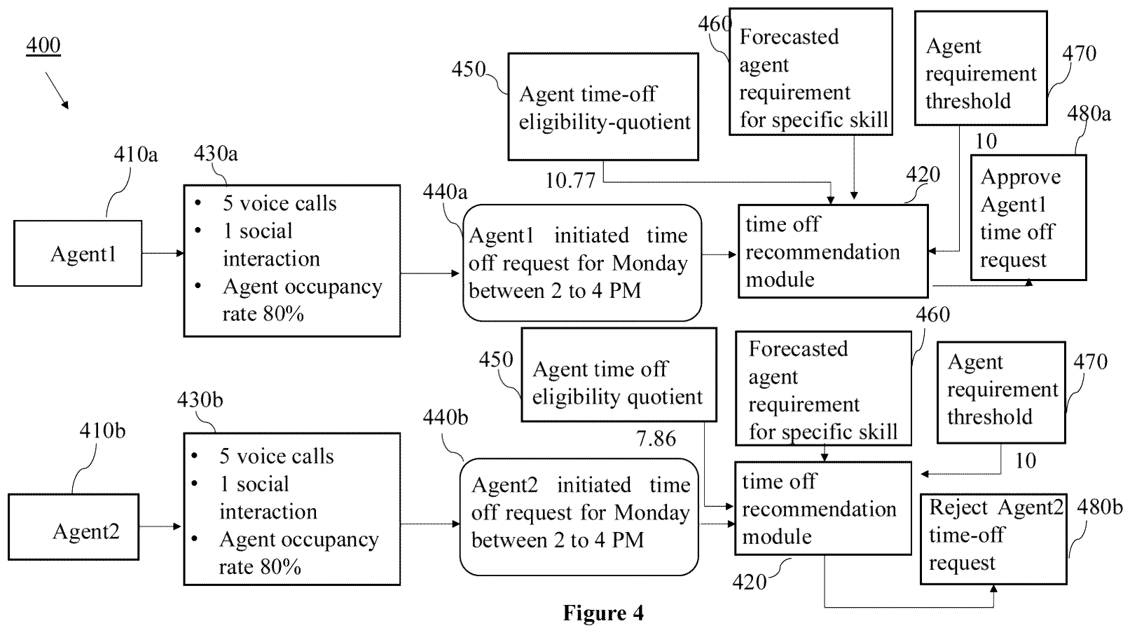

According to some embodiments of the present disclosure, for each skill of the of the one or more skills in the agent skill-based time-off request, e.g., credit card theft and Spanish, the agent-skill-based time-off module 120b may calculate an agent time-off eligibility-quotient. When the agent time-off eligibility-quotient, e.g., ‘7.86’ is below a preconfigured quotient-threshold e.g., ‘10’, the agent skill-based time-off request may be rejected, as shown in FIG. 4, element 480b.

According to some embodiments of the present disclosure, when the agent time-off eligibility-quotient, e.g., ‘10.77’ is above the preconfigured quotient-threshold, e.g., ‘10’, the agent-skill-based time-off module 120b may operate a module, such as an approver module 130b to yield an authorization decision.

According to some embodiments of the present disclosure, the authorization decision, details of the skill and duration of the time-off requested may be sent to a time-off recommendation module 140b to forward the authorization decision, details of the skill and duration to one or more contact-center modules.

According to some embodiments of the present disclosure, the one or more contact-center modules 170 in FIG. 1A, may be supervisor dashboard 170a, a routine engine 170c and a scheduling engine 170d. The authorization decision may be stored in a database, such as agents database 160b and may be used as inputs for reporting 170b. For example, a list of all agents that took time-off during a specified period and the time-off details, i.e., skill and duration.

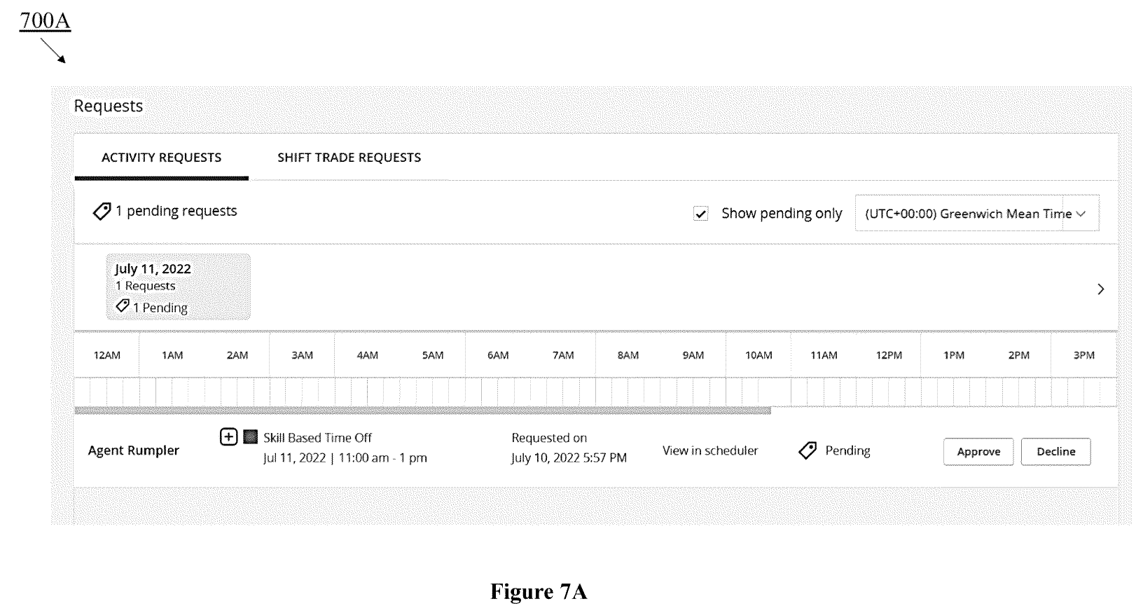

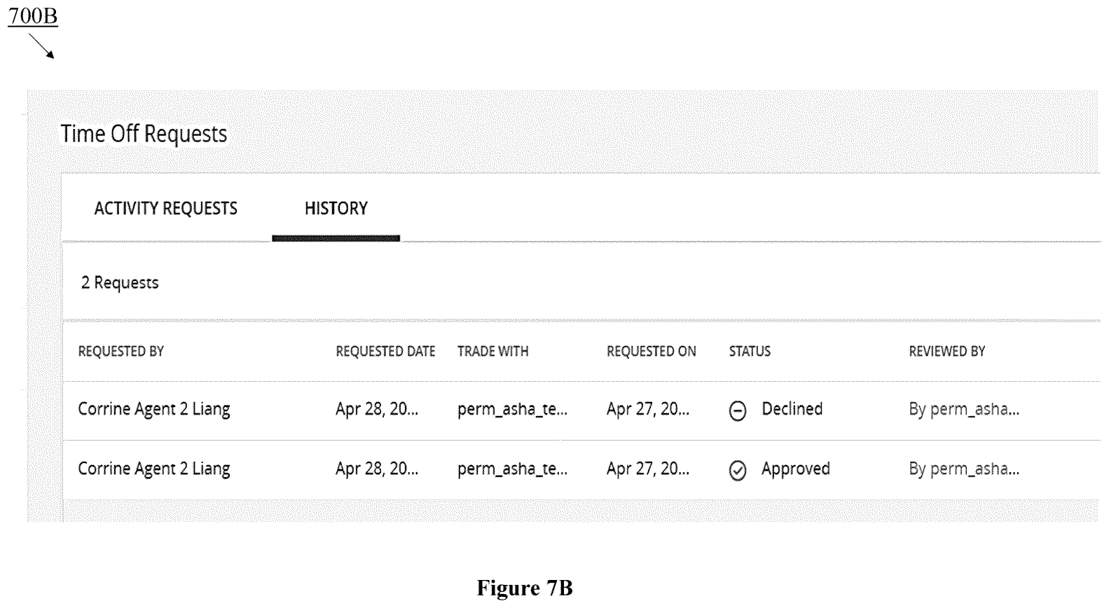

According to some embodiments of the present disclosure, the supervisor dashboard 170a may present each pending agent skill-based time-off request and each approved or rejected agent skill-based time-off request, as shown in User Interfaces 7004-700B in FIGS. 7A-7B.

According to some embodiments of the present disclosure, the routing engine 170c may be configured to check the agents database 160b before routing an inbound-interaction to the agent, and when the inbound-interaction requires an agent with a specified skill, the routing engine is not routing the inbound-interaction to an agent that has the specified skill marked as ‘unavailable’ in the agents database 160b.

According to some embodiments of the present disclosure, the approver module 130b may include: (i) calculating a scheduled-agent-availability for one or more schedules in the duration; (ii) marking the authorization decision as ‘approved’ when the scheduled-agent-availability is marked as ‘on’; and (iii) marking the authorization decision as ‘rejected’ when the scheduled-agent-availability is marked as ‘off’.

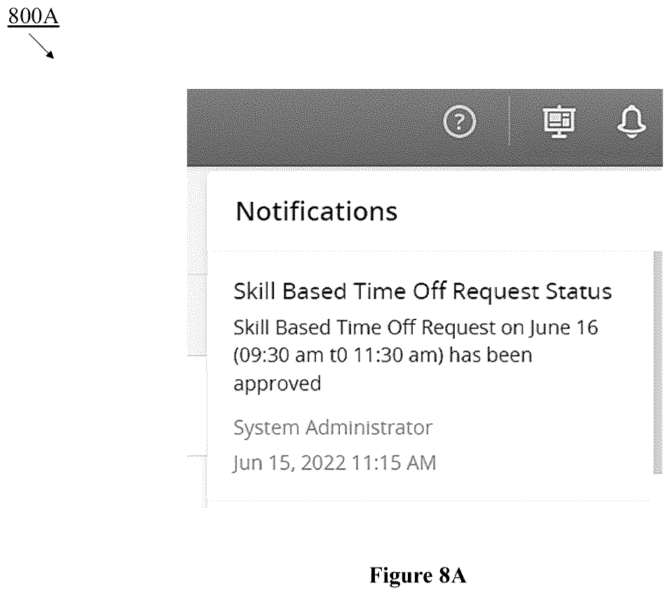

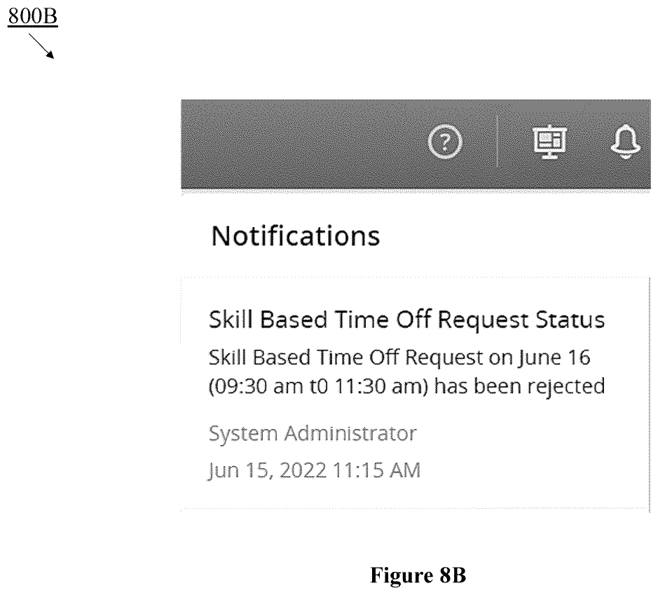

According to some embodiments of the present disclosure, when the authorization decision is marked as ‘approved’, the approver module 130b may mark the skill of the agent as ‘unavailable’ in the agents database 160b with details of the duration of the time-off requested and when the authorization decision is marked as ‘rejected’, the approver module 130b may send a deny notification with details of the skill and duration to the computerized-device of the agent 110b. For example, as shown in notification 800B in FIG. 8B.

According to some embodiments of the present disclosure, the duration details of the requested time-off may include start date and time and end date and time of the time-off request.

According to some embodiments of the present disclosure, after receiving the agent skill-based time-off request, the database of agents 160b may be checked if the agent has already one or more skills which are marked as ‘unavailable’, and when the agent has one or more skills which are marked as ‘unavailable’, the received agent skill-based time-off request may be rejected.

According to some embodiments of the present disclosure, after receiving the agent skill-based time-off request, the database of agents 160b may be checked if the agent has the skill marked as ‘unavailable’, and when the agent has the skill marked as ‘unavailable’, the received agent skill-based time-off request may be rejected.

According to some embodiments of the present disclosure, the approver module 130b may mark the scheduled-agent-availability marked as ‘on’, when a scheduled-agent-count is greater than a sum of an agent-requirement-count and an agent requirement threshold and mark the scheduled-agent-availability as ‘off’, when a scheduled-agent-count is lower than the sum of an agent-requirement-count and an agent requirement threshold.

According to some embodiments of the present disclosure, the approver module 130b may further include retrieving the agent-requirement-count for each schedule of one or more schedules in the duration of the time-off requested and the agent requirement threshold for each schedule from an agents database.

According to some embodiments of the present disclosure, when the decision is time-off approval for the skill, an approval-notification may be sent by an approval notification module to be presented via a UI 110b on a display unit associate to the computerized-device of the agent. For example, as shown in notification 800A in FIG. 8A.

According to some embodiments of the present disclosure, the agent time-off eligibility-quotient is calculated based on following formula I:
(I) agent time-off eligibility-quotient=Σ(agent quotient+agent skill quotient)/(K+L) whereby:
   the agent quotient is calculated by following formula II:

$$agent quotient = {\sum }_{k = 1}^{k} {agent\_parameter}_{k} * preconfigured\_parameter {\_weight}_{k} \qquad ( II )$$

whereby:
k is a number of preconfigured one or more agent_parameters, and
preconfigured_parameter_weight is a corresponding weight that is determined for each preconfigured agent_parameter of the preconfigured one or more agent_parameters, and
the agent skill quotient is calculated based on following formula III:

$$agent skill quotient = {\sum }_{L = 1}^{L} {agent\_performance}_{L} * {preconfigured\_weight}_{L} \qquad ( III )$$

whereby:
L is a number of preconfigured one or more agent_perfonnances, and preconfigured_weight is a corresponding weight that is determined for each preconfigured agent_performance of the preconfigured one or more agent_performances.

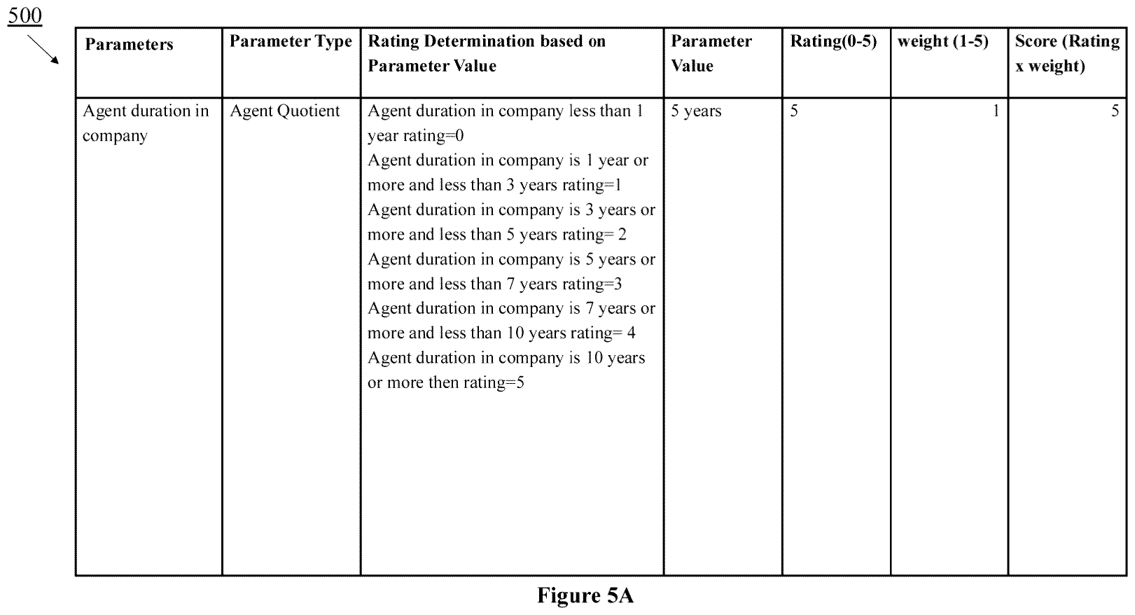

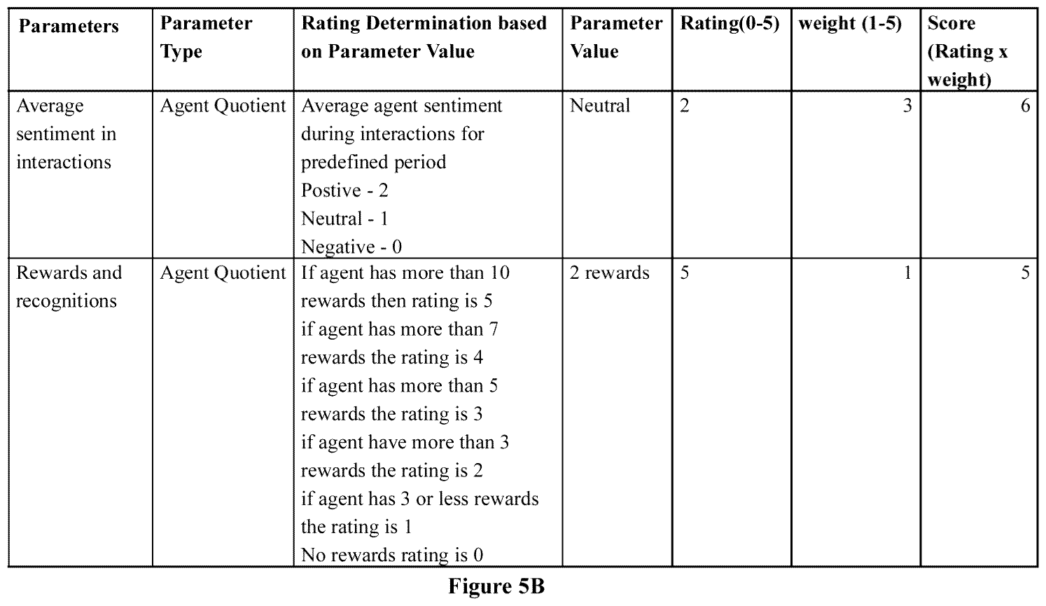

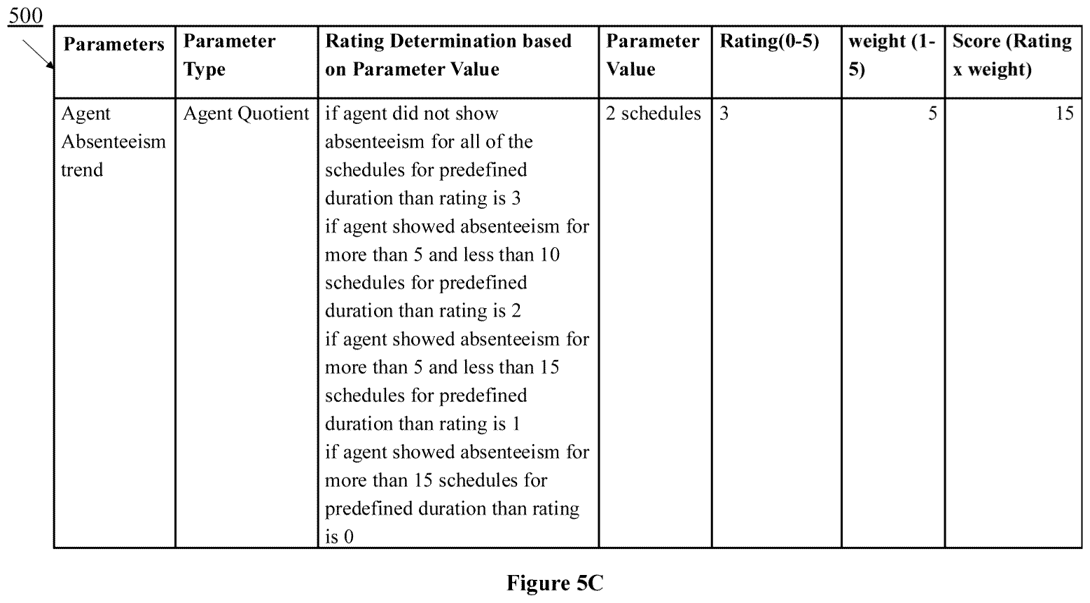

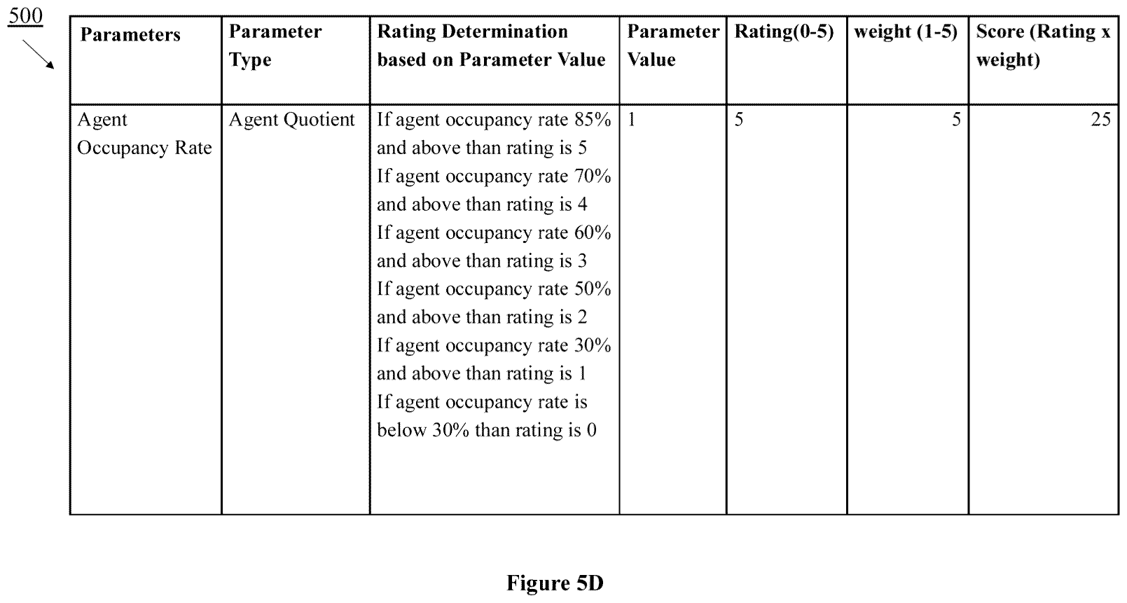

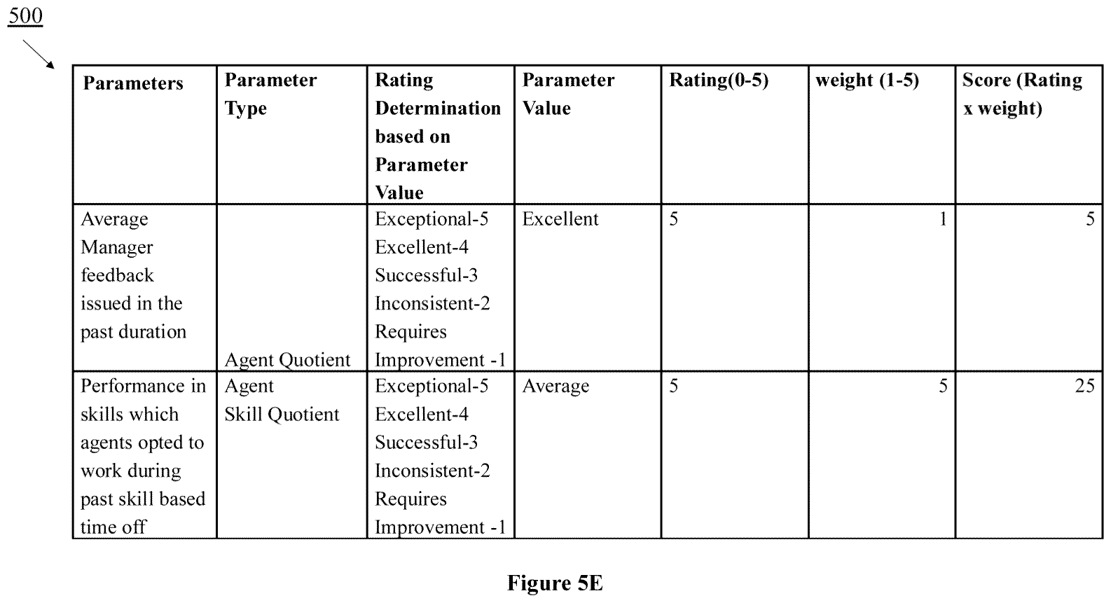

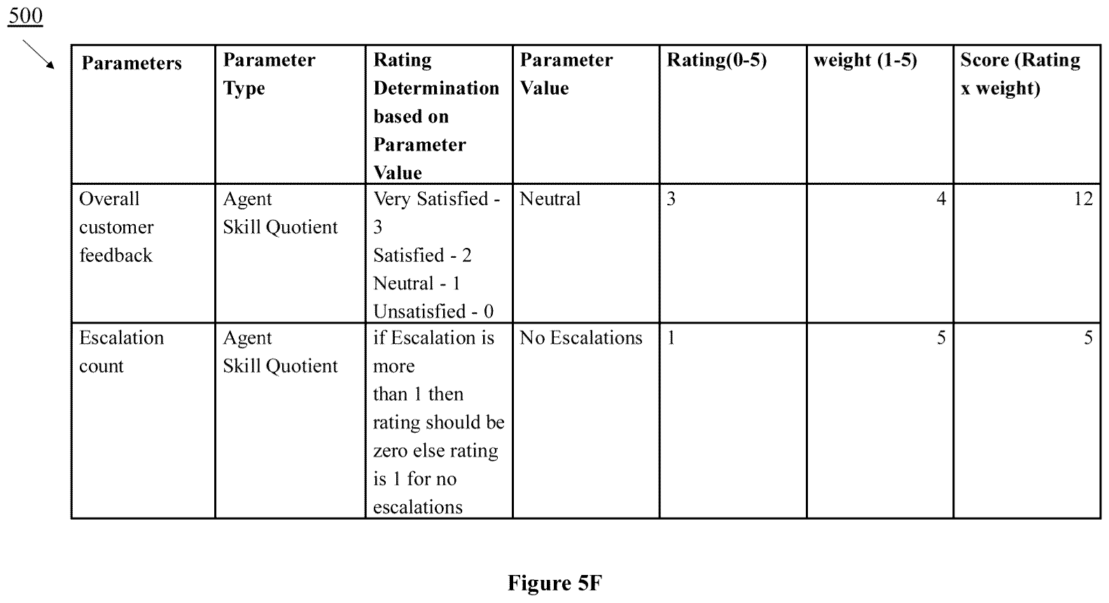

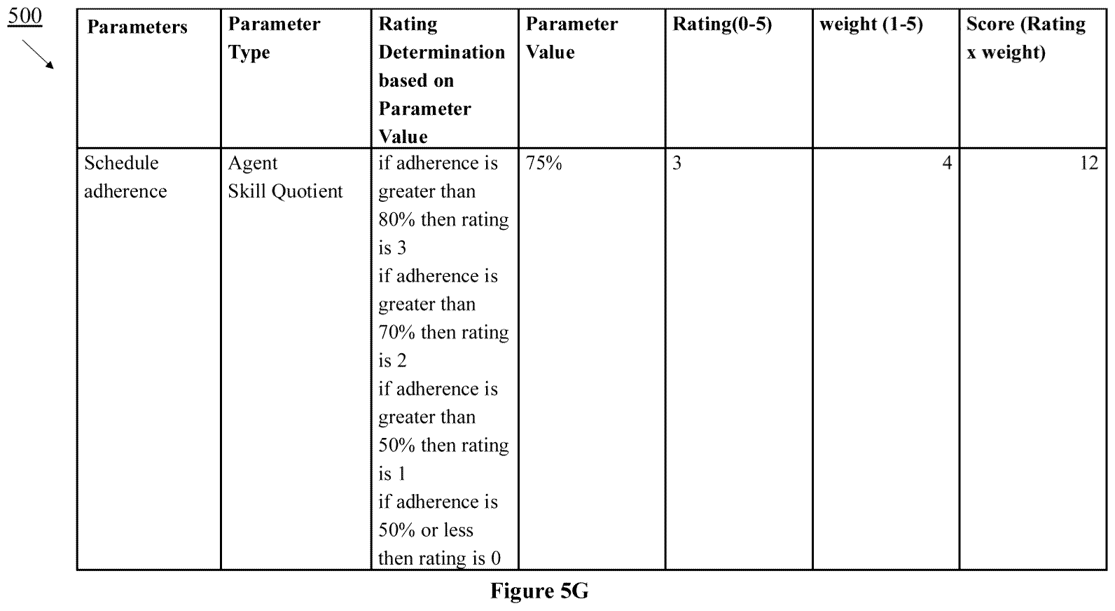

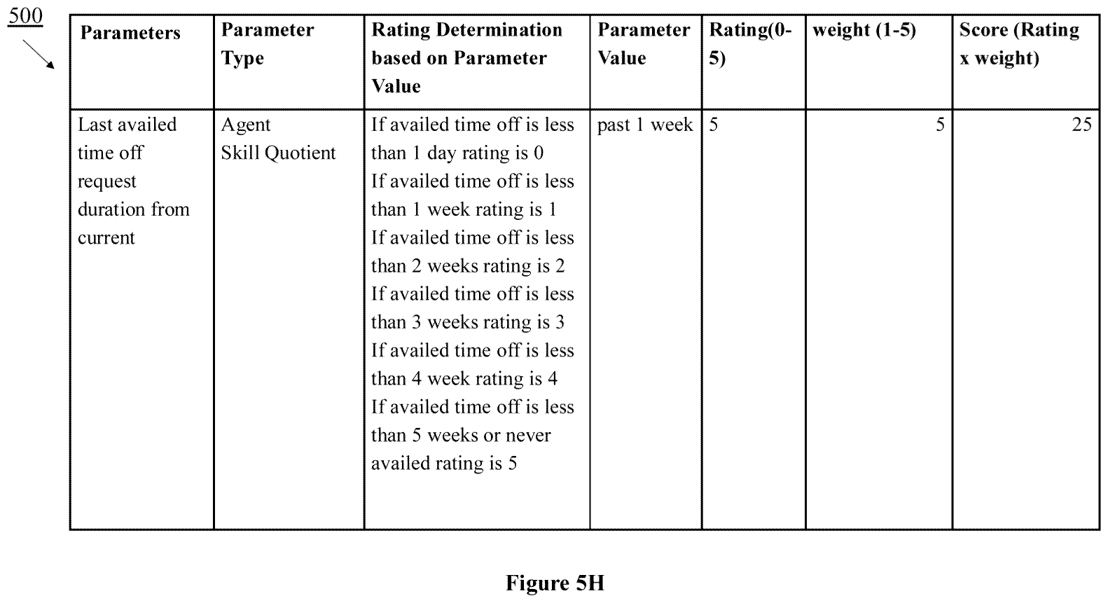

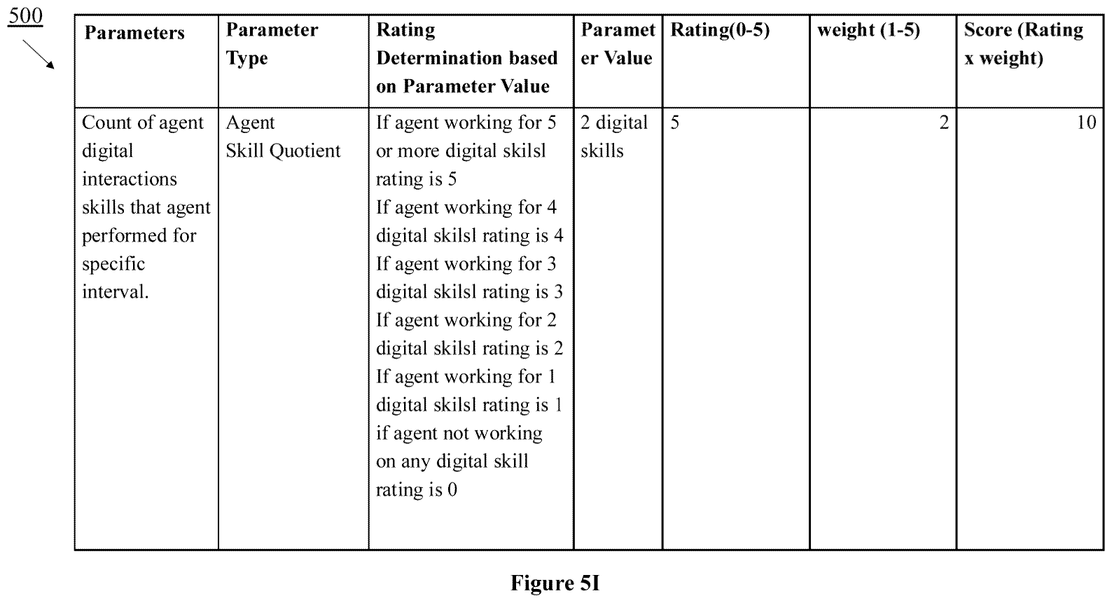

According to some embodiments of the present disclosure, parameters which are related to the agent, such as the one or more agent_parameters, may be selected from at least one of: (i) agent duration in company; (ii) average sentiment in interactions of the agent during a preconfigured period; (iii) rewards and recognitions accredited to the agent during the preconfigured period; (iv) agent absenteeism rate during the preconfigured period; (v) agent occupancy rate; and (vi) average manager-feedback issued during the preconfigured period. For example, agent related parameters, i.e., agent quotient, as shown in FIGS. 5A-5E.

According to some embodiments of the present disclosure, the agent duration in the company parameter for each agent may include points based on the duration period of the agent in the company. The average sentiment in interactions of the agent during a preconfigured period is an average value of sentiment score of each interaction the agent had in the preconfigured period Rewards and recognitions accredited to the agent for performance during the preconfigured period may be considered in the calculation of agent time-off eligibility-quotient which affects the authorization of time-off request.

According to some embodiments of the present disclosure, agent absenteeism rate during the preconfigured period may be considered for the decision in the calculation of agent time-off eligibility-quotient. The agent occupancy rate measures the percentage of logged-in time during which an agent is actually delivering customer service. The average manager-feedback issued during the preconfigured period relates to manager-feedback to interactions of the agent during the preconfigured period.

According to some embodiments of the present disclosure, parameters which are related to performance of the agent when providing service with the skill that a time-off request has been received in the system 100B may be parameters which reflect the one or more agent performances during a preconfigured period and may be selected from at least one of: (i) average performance in skills that the agent opted to work when one or more skills were marked as ‘unavailable’ during the preconfigured period; (ii) average customer feedback during the preconfigured period; (iii) escalation count during the preconfigured period; (iv) schedule adherence of agent in shifts during the preconfigured period; (v) last availed time-off request duration from the agent skill-based time-off; and (vii) number of agent digital interactions skills that the agent performed for the preconfigured period. For example, agent skill related parameters, i.e., agent skill quotient, as shown in FIGS. 5E-5I.

According to some embodiments of the present disclosure, the average performance in skills that the agent opted to work when one or more skills were marked as ‘unavailable’ during the preconfigured period relates to measured performance in skills that were not marked as ‘unavailable’ in previous agent skill-based time-off requests.

According to some embodiments of the present disclosure, the escalation count during the preconfigured period relates to the number of interactions of the agent, which has been escalated during the preconfigured period. The schedule adherence of agent in shifts during the preconfigured period relates to the rate that the agent conforms to the schedule. The last availed time-off request duration from the agent skill-based time-off relates to the time that past from last agent skill-based time-off request. The number of agent digital interactions skills that the agent performed for the preconfigured period relates to the number of interactions that the agent has provided customer service which required a digital channel.

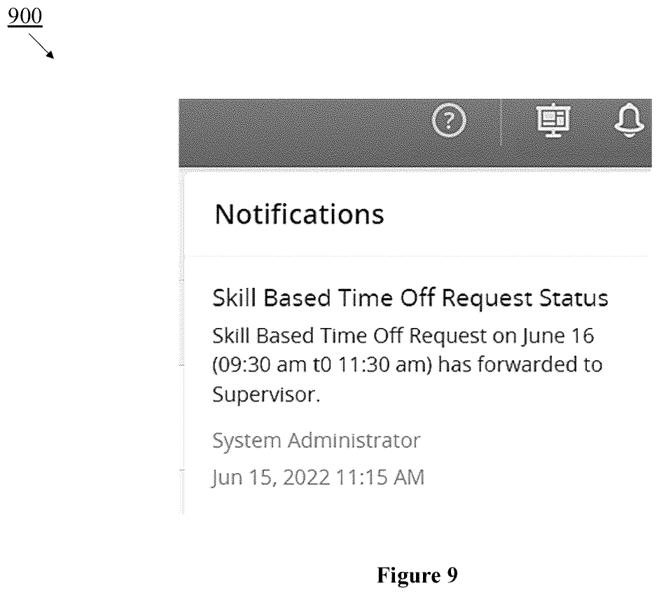

According to some embodiments of the present disclosure, the agent skill-based time-off request may be forwarded to a supervisor for approval when the eligibility-quotient is below the preconfigured quotient-threshold. Instead of rejecting the agent skill-based time-off request, the agent skill-based time-off request may be sent to a supervisor dashboard to be presented to a supervisor which may be enabled to approve it. Accordingly, the agent may receive a notification, as shown in notification 900, in FIG. 9

According to some embodiments of the present disclosure, the operating of the agent-skill-based tune-off module 120b, may be after one or more preconfigured system validations are satisfied. The agent skill-based time-off request may be rejected when one or more preconfigured system validations are not satisfied.

According to some embodiments of the present disclosure, the operating of the agent-skill-based tune-off module 120b, may be before one or more preconfigured system validations are satisfied. The agent skill-based time-off request may be rejected when one or more preconfigured system validations are not satisfied.

According to some embodiments of the present disclosure, the one or more preconfigured system validations may be selected from at least one of: (i) the duration of the agent skill-based time-off request is not in a period that has been configured as a period when a high number of interactions is expected; (ii) a preconfigured first-quota for all scheduled agents for agent skill-based time-off requests has not been reached in a first-preconfigured period; (iii) a preconfigured second-quota for the agent for agent skill-based tune-off requests per a second-preconfigured period has not been reached; and (iv) excess number of agents for the skill in the duration of the agent skill-based time-off request.

FIG. 2 is a high-level workflow of a computerized-method 200 for authorizing time-off for a skill to increase agents digital availability, in accordance with some embodiments of the present disclosure.

According to some embodiments of the present disclosure, operation 210 comprising receiving an agent skill-based time-off request having one or more skills and a duration from a User Interface (UI) in a computerized-device of an agent for each skill of the one or more skills in the agent skill-based time-off request performing operations 220-240.

According to some embodiments of the present disclosure, operation 220 comprising operating an agent-skill-based time-off module to calculate an agent time-off eligibility-quotient.

According to some embodiments of the present disclosure, operation 230a comprising rejecting the agent skill-based time-off request when the agent time-off eligibility-quotient is below a preconfigured quotient-threshold.

According to some embodiments of the present disclosure, operation 230b comprising operating an approver module to yield an authorization decision when the agent time-off eligibility-quotient is above the preconfigured quotient-threshold

According to some embodiments of the present disclosure, operation 240 comprising sending the authorization decision, details of the skill and duration to a time-off recommendation module to forward the authorization decision, details of the skill and duration to one or more contact-center modules.

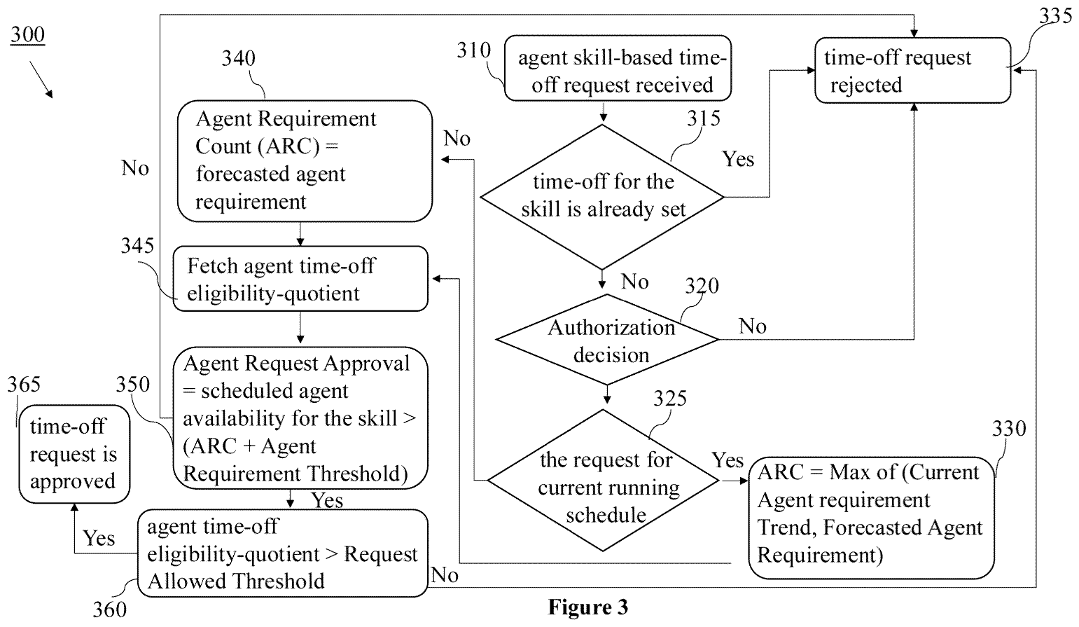

FIG. 3 is a flowchart of a computerized-method 300 for authorizing time-off for a skill to increase agents digital availability, in accordance with some embodiments of the present disclosure.

According to some embodiments of the present disclosure, an agent skill-based time-off request may be received 310 in a system such as system 100A in FIG. 1A and such as system 100B in FIG. 1B. The tune-off request may be for one or more skills of an agent having two or more skills.

According to some embodiments of the present disclosure, for each skill in the one or more skills of the agent skill-based time-off request, a check if a time-off for the skill is already set 315 may be operated 315.

According to some embodiments of the present disclosure, when there is no time-off for the skill, an authorization decision 320 may be made by a module, such as agent-skill-based time-off module 120a in FIG. 1A and such as agent-skill-based time-off module 120b in FIG. 1B which may calculate an agent time-off eligibility-quotient.

According to some embodiments of the present disclosure, when there is a time-off already set for the skill in a database, such as agents database 160b in FIG. 1B, the time-off request may be rejected 335.

According to some embodiments of the present disclosure, when the agent time-off eligibility-quotient is below a preconfigured quotient-threshold, the agent skill-based time-off request may be rejected 335.

According to some embodiments of the present disclosure, when the agent time-off eligibility-quotient is above the preconfigured quotient-threshold in case the duration of the agent skill-based time-off request is for current running schedule 325 then a module, such as an approver module 130a in FIG. 1A and such as approver module 130b in FIG. 1B, may check the Agent Requirement Count (ARC) for the skill and the duration of the time-off requested. The ARC, may be calculated by maximum value of current agent requirement trend and the forecasted agent requirement 330.

According to some embodiments of the present disclosure, when the agent time-off eligibility-quotient is above the preconfigured quotient-threshold, in case the duration of the agent skill-based time-off request is not for current running schedule, the ARC is the forecasted agent requirement.

According to some embodiments of the present disclosure, the agent time-off eligibility-quotient may be fetched 345 and then an Agent Request Approval (ARA) may be calculated 350. The ARA may be checked to validate that the scheduled agent availability is greater than the sum of ARC and Agent Requirement Threshold (ART) 350.

According to some embodiments of the present disclosure, when the ARA is greater than the sum of ARC and ART, then checking if agent time-off eligibility-quotient is above the ART 360. A scheduled-agent-availability may be marked as ‘on’, when a scheduled-agent-count is greater than a sum of an agent-requirement-count and an agent requirement threshold, and the agent time-off eligibility-quotient is above the ART, then the time-off request may be approved 365.

According to some embodiments of the present disclosure, when the ARA is not greater than the sum of ARC and ART then the time-off request may be rejected 335.

According to some embodiments of the present disclosure, when the agent time-off eligibility-quotient is below the ART then the time-off request may be rejected 335.

According to some embodiments of the present disclosure, the scheduled-agent-availability may be marked as ‘off’, when a scheduled-agent-count is lower than the sum of an agent-requirement-count and an agent requirement threshold.

FIG. 4 shows an example 400 of usage of a computerized-method 400 for authorizing time-off for a skill to increase agents digital availability, in accordance with some embodiments of the present disclosure.

According to some embodiments of the present disclosure, a computerized-method, such as computerized-method for authorizing time-off for a skill to increase agents digital availability 200 in FIG. 2, may be implemented in a system, such as system 100A in FIG. 1A or such as system 100B in FIG. 1B

According to some embodiments of the present disclosure, an agent skill-based time-off request may be received from agent 410. The agent1 410a may have the following parameters: voice calls, 1 social interaction and agent occupancy rate 80% as listed in element 430a. The agent 410a may have initiated a time-off request for Monday between 2 to 4 PM.

According to some embodiments of the present disclosure, agent2 410b may have the same parameters as agent 410a, listed in element 430b. Agent2 410b may have also initiated a time-off request for Monday between 2 to 4 PM.

According to some embodiments of the present disclosure, a module, such as time-off recommendation module 420, and such as time-off recommendation module 140a in FIG. 1A and such as time-off recommendation module 140b in FIG. 1B, may approve agent1 time-off request 480a and reject agent2 time-off request of 480b.

According to some embodiments of the present disclosure, an authorization decision of approval or rejection may be sent to the time-off recommendation module 420. The authorization decision may be yielded by a module, such as au approver module 130a in FIG. 1A and such as approver module 130b in FIG. 1B.

According to some embodiments of the present disclosure, the approver module may include retrieving the agent-requirement-count for each schedule of one or more schedules in the duration and the agent requirement threshold for each schedule from an agents database. The approver module may also include calculating a scheduled-agent-availability. The scheduled-agent-availability may be marked as ‘on’, when a scheduled-agent-count is greater than a sum of an agent-requirement-count and an agent requirement threshold, and the scheduled-agent-availability is marked as ‘off’, when a scheduled-agent-count is lower than the sum of an agent-requirement-count and an agent requirement threshold.

According to some embodiments of the present disclosure, based on the scheduled-agent-availability and agent time-off eligibility-quotient, the time-off request may be rejected or approved. For example, agent1 410a may have a calculated agent time-off eligibility-quotient of ‘10.77’, therefore, when the preconfigured quotient-threshold is ‘10’ then an approver module may be operated to yield an authorization decision. The authorization decision may be based on forecasted agent requirement for specific skill 460 and agent requirement threshold 470.

According to some embodiments of the present disclosure, in another example, agent2 410b may have a calculated agent time-off eligibility-quotient of ‘7.86’, therefore, when the preconfigured quotient-threshold is ‘10’ and the preconfigured quotient-threshold is ‘10’ then the time-off request for the skill may be rejected 480b.

FIGS. 5A-5I shown an example 500 of agent time-off eligibility-quotient calculation based on agent quotient and agent skills quotient, in accordance with some embodiments of the present disclosure.

According to some embodiments of the present disclosure, agent duration in company parameter which is an agent quotient type parameter, may have for example, rating determination based on the parameter value, such as Agent duration in company less than 1 year then rating, Agent duration in company is 1 year or more and less than 3 years rating=1, Agent duration in company is 3 years or more and less than 5 years rating=2, Agent duration in company is 5 years or more and less than 7 years rating=3, Agent duration in company is 7 years or more and less than 10 years rating=4 and Agent duration in company is 10 years or more then rating=5. When the, agent duration in company parameter is 2 years the rating may be 5 and it may have an associated weight 1 out of 5, e.g., preconfigured_parameter_weight as in formula II, and the score may be 5 calculated by agent_parameter k*preconfngured_parameter_weight k.

According to some embodiments of the present disclosure, average sentiment in interactions is a parameter that relates average sentiment in interactions of the agent during a preconfigured period. Average sentiment in interactions is an agent quotient type parameter, which may have for example, rating determination based on the parameter value, such as Positive-2 Neutral-1 Negative-0.

According to some embodiments of the present disclosure, when the average sentiment in interactions is 2 and it may have an associated weight 3 out of 5 e.g., the preconfigured_parameter_weight, then the score may be 6, calculated by agent_parameter k preconfigured_parameter_weight k.

According to some embodiments of the present disclosure, rewards and recognitions is a parameter that relates to rewards and recognitions accredited to the agent during the preconfigured period. Rewards and recognitions is an agent quotient parameter, which may have for example, rating determination based on the parameter value, such as if agent has more than 10 rewards then rating is 5, if agent has more than 7 rewards the rating is 4, if agent has more than 5 rewards the rating is 3, if agent have more than 3 rewards the rating is 2, if agent has 3 or less rewards the rating is 1 No rewards rating is 0.

According to some embodiments of the present disclosure, when the rewards and recognitions parameter value is 2 rewards, then the rating may be 5 and it may have an associated weight 5 out of 5 e.g., the preconfigured_parameter_weight, then the score may be 5, calculated by agent_parameter k*preconfigured_parameter_weight k.

According to some embodiments of the present disclosure, agent absenteeism trend is a parameter that relates to agent absenteeism rate during the preconfigured period. Agent absenteeism trend is an agent quotient parameter, which may have for example, rating determination based on the parameter value, such as if agent did not show absenteeism for all of the schedules for predefined duration than rating is 3, if agent showed absenteeism for more than 5 and less than 10 schedules for predefined duration than rating is 2, if agent showed absenteeism for more than 5 and less than 15 schedules for predefined duration than rating is 1, if agent showed absenteeism for more than 15 schedules for predefined duration than rating is 0.

According to some embodiments of the present disclosure, when the agent absenteeism parameter value is 2 schedules, then the rating may be 3 and it may have an associated weight 5 out of 5 e.g., the preconfigured_parameter_weight, then the score may be 15, calculated by agent_parameter k*preconfigured_parameter_weight k.

According to some embodiments of the present disclosure, agent occupancy rate is an agent quotient parameter which may have for example, rating determination based on the parameter value, such as if agent occupancy rate 85% and above than rating is 5, if agent occupancy rate 70% and above than rating is 4, if agent occupancy rate 60% and above than rating is 3, if agent occupancy rate 50% and above than rating is 2, if agent occupancy rate 30% and above than rating is 1, if agent occupancy rate is below 30% than rating is 0.

According to some embodiments of the present disclosure, when the agent occupancy rate parameter value is 1, then the rating may be 5 and it may have an associated weight 5 out of 5 e.g., the preconfigured_parameter_weight, then the score may be 25, calculated by agent_parameter k*preconfigured_parameter_weight k.

According to some embodiments of the present disclosure, average manager feedback issues in the past duration may be a parameter related to average manager-feedback issued during the preconfigured period. The average manager feedback issues in the past duration parameter is an agent quotient parameter which may have for example, rating determination based on the parameter value, such as Exceptional-5, Excellent-4, Successful-3, Inconsistent-2, Requires Improvement-1.

According to some embodiments of the present disclosure, when average manager feedback issues in the past duration parameter value is Excellent, then the rating may be 5 and it may have an associated weight 1 out of 5, e.g., the preconfigured_parameter_weight, then the score may be 5, calculated by agent_parameter k*preconfigured_parameter_weight k.

According to some embodiments of the present disclosure, performance in skills which agents opted to work during past skill-based time off is a parameter related to average performance in skills that the agent opted to work when one or more skills were marked as unavailable during the preconfigured period. It is an agent skill quotient parameter which may have for example, rating determination based on the parameter value, such as Exceptional-5, Excellent-4, Successful-3 Inconsistent-2, Requires Improvement-1.

According to some embodiments of the present disclosure, when performance in skills which agents opted to work during past skill based time off value is Average, then the rating may be 5 and it may have an associated weight 5 out of 5, e.g., the preconfigured_parameter_weight, then the score may be 25, calculated by agent_parameter k*preconfigured_parameter_weight k.

According to some embodiments of the present disclosure, average customer feedback is a parameter that relates to average customer feedback during the preconfigured period. It is an agent skill quotient parameter which may have for example, rating determination based on the parameter value, such as Very Satisfied-3, Satisfied-2, Neutral-1, Unsatisfied-0.

According to some embodiments of the present disclosure, when average customer feedback parameter value is Neutral, then the rating may be 3 and it may have au associated weight 4 out of 5, e.g., the preconfigured_parameter_weight, then the score may be 12, calculated by agent_parameter k*preconfigured_parameter_weight k.

According to some embodiments of the present disclosure, escalation count parameter is a parameter that relates to escalation count during the preconfigured period. It is an agent skill quotient parameter which may have for example, if Escalation is more than 1 then rating should be zero else rating is 1 for no escalations.

According to some embodiments of the present disclosure, when escalation count parameter value is No escalations, then the rating may be 1 and it may have an associated weight 5 out of 5. e.g., the preconfigured_parameter_weight, then the score may be 5, calculated by agent_parameter k*preconfigured_parameter_weight k.

According to some embodiments of the present disclosure, schedule adherence is a parameter schedule adherence of agent in shifts during the preconfigured period. It is an agent skill quotient parameter which may have for example, rating determination based on the parameter value, such as if adherence is greater than 80% then rating is 3, if adherence is greater than 70% then rating is 2, if adherence is greater than 50% then rating is 1, if adherence is 50% or less then rating is 0.

According to some embodiments of the present disclosure, when schedule adherence parameter value is 75%, then the rating may be 3 and it may have an associated weight 4 out of 5, e.g., the preconfigured_parameter_weight, then the score may be 12, calculated by agent_parameter k*preconfigured_parameter_weight k.

According to some embodiments of the present disclosure, last availed time off request duration from current is a parameter that relates to last availed time-off request duration from the agent skill-based time-off. It is an agent skill quotient parameter which may have for example, rating determination based on the parameter value, such as if availed time off is less than 1 day rating is 0, if availed time off is less than 1 week rating is 1, if availed time off is less than 2 weeks rating is 2, if availed time off is less than 3 weeks rating is 3, if availed time off is less than 4 week rating is 4, if availed time off is less than 5 weeks or never availed rating is 5.

According to some embodiments of the present disclosure, when last availed time off request duration from current value is past 1 week, then the rating may be 5 and it may have an associated weight 5 out of 5, e.g., the preconfigured_parameter_weight, then the score may be 25, calculated by agent_parameter k*preconfigured_parameter_weight k.

According to some embodiments of the present disclosure, count of agent digital interactions skills that agent performed for specific interval is a parameter that is related to the number of agent digital interactions skills that the agent performed for the preconfigured period. It is an agent skill quotient parameter which may have for example, rating determination based on the parameter value, such as if agent working for 5 or more digital skills rating is 5, if agent working for 4 digital skills rating is 4, if agent working for 3 digital skills rating is 3, if agent working for 2 digital skills rating is 2, if agent working for 1 digital skills rating is 1, if agent not working on any digital skill rating is 0.

According to some embodiments of the present disclosure, when count of agent digital interactions skills that agent performed for specific interval value is 2 digital skills, then the rating may be 5 and it may have an associated weight 5 out of 5, e.g., the preconfigured_parameter_weight, then the score may be 25, calculated by agent_parameter k*preconfigured_parameter_weight k.

FIG. 6 is an example 600 of a User Interface (UI) in a computerized-device of an agent for selecting an agent skill-based time-off request having one or more skills, in accordance with some embodiments of the present disclosure.

According to some embodiments of the present disclosure, a module, such as agent-skill-based time-off module 120a in FIG. 1 may receive an agent skill-based time-off request 600 having one or more skills 610 and a duration for the time-off request from a User Interface (UI) in a computerized-device of an agent. For example, the duration may include a start date 620 and start time 630 and end time 640. The one or more skills 610 for the time-off request may be Facebook and WhatsApp, which means that after the time-off request is approved, the agent won't be routed inbound-interactions via Facebook and WhatsApp application for the duration of Jun. 17, 2022, from 10:30 AM through 12:30 PM.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for authorizing time-off for a skill to increase agents digital availability, the computerized-method comprising:
(i) receiving au agent skill-based time-off request having one or more skills and a duration from a User Interface (UI) in a computerized-device of an agent,
wherein the agent has two or more associated skills;
for each skill of the one or more skills in the agent skill-based time-off request:
(ii) operating an agent-skill-based time-off module to calculate an agent time-off eligibility-quotient,
wherein when the agent time-off eligibility-quotient is below a preconfigured quotient-threshold the agent skill-based time-off request is rejected, and
wherein when the agent time-off eligibility-quotient is above the preconfigured quotient-threshold, operating an approver module to yield an authorization decision; and
(iii) sending the authorization decision, details of the skill and duration to a time-off recommendation module to forward the authorization decision, details of the skill and duration to one or more contact-center modules.

2. The computerized-method of claim 1, wherein said approver module comprising:
(i) calculating a scheduled-agent-availability for one or more schedules in the duration;
(ii) matting the authorization decision as ‘approved’ when the scheduled-agent-availability is marked as ‘on’; and
(iii) marking the authorization decision as ‘rejected’ when the scheduled-agent-availability is marked as ‘off’,
wherein when the authorization decision is marked as ‘approved’, marking the skill of the agent as ‘unavailable’ in au agents database with details of the duration; and
wherein when the authorization decision is marked as ‘rejected’, sending a deny notification with details of the skill and duration to the computerized-device of the agent.

3. The computerized-method of claim 1, wherein the duration details comprising start date and time and end date and time.

4. The computerized-method of claim 1, wherein after receiving the agent skill-based time-off request, checking in the database of agents if the agent has one or more skills marked as ‘unavailable’, and when the agent has one or more skills marked as ‘unavailable’, the received agent skill-based time-off request is rejected.

5. The computerized-method of claim 1, wherein after receiving the agent skill-based time-off request, checking in the database of agents if the agent has the skill marked as ‘unavailable’, and when the agent has the skill marked as ‘unavailable’, the received agent skill-based time-off request is rejected.

6. The computerized-method of claim 2, wherein the scheduled-agent-availability is marked as ‘on’, when a scheduled-agent-count is greater than a sum of au agent-requirement-count and an agent requirement threshold, and wherein the scheduled-agent-availability is marked as ‘off’, when a scheduled-agent-count is lower than the sum of an agent-requirement-count and an agent requirement threshold.

7. The computerized-method of claim 1, wherein the approver module is further comprising: retrieving the agent-requirement-count for each schedule of one or more schedules in the duration and the agent requirement threshold for each schedule from an agents database.

8. The computerized-method of claim 1, wherein when the decision is time-off approval for the skill, the computerized-method is further comprising sending an approval-notification by an approval notification module to be presented via a III on a display unit associate to the computerized-device of the agent.

9. The computerized-method of claim 1, wherein the agent time-off eligibility-quotient is calculated based on following formula I:
(II) agent time-off eligibility-quotient=E (agent quotient+agent skill quotient)/(K+L)
whereby:
the agent quotient is calculated by following formula II:
$$agent quotient = {\sum }_{k = 1}^{k} {agent\_parameter}_{k} * preconfigured\_parameter {\_weight}_{k} \qquad ( II )$$
whereby:
k is a number of preconfigured one or more agent_parameters, and
preconfigured_parameter_weight is a corresponding weight that is determined for each preconfigured agent_parameter of the preconfigured one or more agent_parameters, and
the agent skill quotient is calculated based on following formula III:
$$agent skill quotient = {\sum }_{L = 1}^{L} {agent\_performance}_{L} * {preconfigured\_weight}_{L} \qquad ( IV )$$
whereby:
L is a number of preconfigured one or more agent_perfonnances, and
preconfigured_weight is a corresponding weight that is determined for each preconfigured agent_performance of the preconfigured one or more agent_perfonnances.

10. The computerized-method of claim 9, wherein the one or more agent_parameters are selected from at least one of: (i) agent duration in company; (ii) average sentiment in interactions of the agent during a preconfigured period; (iii) rewards and recognitions accredited to the agent during the preconfigured period; (iv) agent absenteeism rate during the preconfigured period; (v) agent occupancy rate; and (vi) average manager-feedback issued during the preconfigured period.

11. The computerized-method of claim 9, wherein the one or more agent performances during a preconfigured period are selected from at least one of: (i) average performance in skills that the agent opted to work when one or more skills were marked as unavailable during the preconfigured period; (ii) average customer feedback during the preconfigured period; (iii) escalation count during the preconfigured period; (iv) schedule adherence of agent in shifts during the preconfigured period; (v) last availed time-off request duration from the agent skill-based time-off; and (vii) number of agent digital interactions skills that the agent performed for the preconfigured period.

12. The computerized-method of claim 1, wherein the agent skill-based time-off request is forwarded to a supervisor for approval when the eligibility-quotient is below the preconfigured quotient-threshold.

13. The computerized-method of claim 1, wherein the one or more contact-center modules include at least one of: (i) supervisor dashboard; (ii) reporting generator; (iii) routing engine; and (iv) scheduling engine.

14. The computerized-method of claim 13, wherein the supervisor dashboard presents each pending agent skill-based time-off request and each approved or rejected agent skill-based time-off request.

15. The computerized-method of claim 13, wherein the routing engine is configured to check the agents database before routing an inbound-interaction to the agent, and when the inbound-interaction requires an agent with a specified skill, the routing engine is not routing the inbound-interaction to an agent that has the specified skill marked as ‘unavailable’.

16. The computerized-method of claim 1, wherein the operating of the agent-skill-based time-off module, is after one or more preconfigured system validations are satisfied and wherein the agent skill-based time-off request is rejected when one or more preconfigured system validations are not satisfied.

17. The computerized-method of claim 1, wherein the operating of the agent-skill-based time-off module, is before one or more preconfigured system validations are satisfied and wherein the agent skill-based time-off request is rejected when one or more preconfigured system validations are not satisfied.

18. The computerized-method of claim 16, wherein the one or more preconfigured system validations are selected from at least one of: (i) the duration of the agent skill-based time-off request is not in a period that has been configured as a period when a high number of interactions is expected; (ii) a preconfigured first-quota for all scheduled agents for agent skill-based time-off requests has not been reached in a fast-preconfigured period; (iii) a preconfigured second-quota for the agent for agent skill-based time-off requests per a second-preconfigured period has not been reached; and (iv) excess number of agents for the skill in the duration of the agent skill-based time-off request.

19. A computerized-system for authorizing time-off for a skill to increase agents digital availability, the computerized-system comprising:
a memory to store one or more databases thereon,
one or more processors, said one or more processors are configured to:
(i) receive an agent skill-based time-off request having one or more skills and a duration from a User Interface (UI) in a computerized-device of an agent,
wherein the agent has two or more associated skills;
for each skill of the one or more skills in the agent skill-based time-off request:
(ii) operate an agent-skill-based time-off module to calculate an agent time-off eligibility-quotient,
wherein when the agent time-off eligibility-quotient is below a preconfigured quotient-threshold the agent skill-based time-off request is rejected,
wherein when the agent time-off eligibility-quotient is above the preconfigured quotient-threshold, operating an approver module to yield an authorization decision; and
(iii) send the authorization decision, details of the skill and duration to a time-off recommendation module to forward the authorization decision, details of the skill and duration to one or more contact-center modules.
